(19) United States
(12) Patent Application Publication
(10) Pub. No.: US 2008/0045177 A1
(43) Pub. Date: Feb. 21, 2008

(54) System and Method for Configuring Wireless Communication Devices

(75) Inventor: Andrew Wise, Glendale, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Canduit Technologies, LLC, Gilbert, AZ (US)

(21) Appl. No.: 11/828,014

(22) Filed: Jul. 25, 2007

Related U.S. Application Data
(60) Provisional application No. 60/833,512, filed on Jul. 25, 2006.

(51) Int. Cl. H04Q 7/20; H04M 11/00

(52) U.S. Cl. 455/403

(57) ABSTRACT

System and method for configuring wireless communication devices. According to an embodiment, the present invention provides a system for customizing. The system includes a user interface for displaying information. The system includes a user input for receiving one or more user input. Additionally, the system includes a memory that has a first portion and a second portion. The first portion includes at least one set of program instructions, and the second portion includes at least one set of contents. The system further includes a first interface that includes a connector. The connector is adaptable to a plurality of connector configurations, which includes a first configuration and a second configuration. The first configuration is capable of disengageably coupling to a first communication device, and the second configuration is capable of disengageably coupling to a second communication device. First communication device and the second communication device are characterized by different makes.

### CROSS-REFERENCES TO RELATED APPLICATIONS

This application claims priority to U.S. Provisional Application No. 60/833,512 (Attorney Docket No. 026102-000100US) filed Jul. 25, 2006, which is incorporated by reference herein.

### BACKGROUND OF THE INVENTION

The present invention relates in general to telecommunication techniques. More particularly, the invention provides a method and system for wireless communication devices. In a specific embodiment, the present invention provides a standalone system for interfacing and customizing (e.g., flashing CDMA mobile devices, unlocking GSM mobile devices, etc.) wireless communication devices. Merely by way of example, the invention is described as it applies to wireless communication systems and methods thereof, but it should be recognized that the invention has a broader range of applicability.

With the advent of information technologies, various systems and methods have been developed for wireless communication system. In a wireless communication system, wireless communication devices, such as cellular phones and pagers, exchange information with a network system via a radio access network.

Complex as they are, wireless communication devices such as the aforementioned, often needs to be customized. For example, it is often desirable for wireless communication devices to update the operating software, to synchronize with a computer, and/or to download ring tones, etc. As another example, a cellular phone owner often needs to “flash” and/or “unlock” her phone. For many of the abovementioned applications, complex and often cumbersome devices are often needed for customizing wireless communication devices. Often, dealers of wireless communication devices are unable to perform the customization and/or configuration service for their customers and would need to send devices to the manufacturer or a specialized third party for the service. As a result, it is often difficult and inconvenient for users of wireless communication devices to customize their devices.

Therefore, an improved system and method for customizing wireless devices is desired.

### BRIEF SUMMARY OF THE INVENTION

The present invention relates in general to telecommunication techniques. More particularly, the invention provides a method and system for wireless communication devices. In a specific embodiment, the present invention provides a standalone system for interfacing and customizing (e.g., flashing CDMA mobile devices, unlocking GSM mobile devices, etc.) wireless communication devices. Merely by way of example, the invention is described as it applies to wireless communication systems and methods thereof, but it should be recognized that the invention has a broader range of applicability.

According to an embodiment, the present invention provides a system for customizing. The system includes a user interface for displaying information. The system also includes a user input for receiving one or more user input. Additionally, the system includes a memory that has a first portion and a second portion. The first portion includes at least one set of program instructions; whereas, the second portion includes at least one set of contents. The system further includes a first interface that involves a connector. For example, the connector is adaptable to a plurality of connector configurations, which itself includes a first configuration and a second configuration. Moreover, the first configuration is capable of disengageably coupling to a first communication device, while the second configuration is capable of disengageably coupling to a second communication device. The first communication device and the second communication device are characterized by different makes. The system also includes a switching logic component that is configured to determine a switch configuration. The switch configuration is associated with a communication device that is disengageably coupled to the connector according to the first configuration. Also, the system includes a switching component that is configured to conform to the switch configuration. Additionally, the system includes a processor that is configured to execute a first set of program instructions. By example, the first set of program instructions is associated with the communication device that is disengageably coupled to the connector. Consequently, the first set of program instructions is configured to modify a configuration of the communication device.

According to another embodiment, the present invention provides a system for customizing wireless communication devices. The system includes a user interface for displaying information. The system also includes a user input for receiving one or more user input. The system additionally includes a memory that includes a first portion and a second portion. For example, the first portion including at least one set of program instructions. The system also includes a first interface, which includes a connector. Therefore, the connector is adaptable to a plurality of connector configurations, which includes a first configuration and a second configuration. Moreover, the first configuration is capable of disengageably coupling to a first communication device; whereas, the second configuration is capable of disengageably coupling to a second communication device. The first communication device and the second communication device are characterized by different makes. The system further includes a selecting component, which is configured to select a switch configuration based on the one or more user input. The switch configuration is associated with a communication device that is disengageably coupled to the connector according to the first configuration. Additionally, the system includes a switching component; the switching component allows the system to be configured to conform to the switch configuration. Furthermore, the system includes a processor that is configured to execute a first set of program instructions. For example, the first set of program instructions is associated with the communication device that is disengageably coupled to the connector. Therefore, the first set of program instructions is configured to modify a configuration of the communication device.

According to yet another embodiment, the present invention provides a method for configuring one or more wireless communication devices. The method includes a step for providing a set of instructions, which includes a plurality of protocols. The method also includes a step for providing at least one interface of which that includes at least one interface including a connector. For example, the connector is adaptable to a plurality of connector configurations, that of a first configuration and a second configuration. The first configuration is capable of disengageably coupling to a first communication device, while the second configuration is capable of disengageably coupling to a second communication device. The first communication device and the second communication device are characterized by different makes. The method also includes a step for connecting a communication device to the connector. The communication device is characterized by a first device type. The method, which includes a step for determining the first device type, also incorporates a step for selecting a first switching configuration for the communication device. For example, the first switching configuration is associated with the first device type. The method additionally includes a step for selecting a first protocol. Thence, the first protocol is associated with the first device type. The method further includes a step for configuring the communication device using the first switching configuration and the first protocol. Finally, the method includes a step for disconnecting the communication device from at least one connector.

It is to be appreciated various embodiments of the present invention provide numerous advantages over conventional techniques. In a specific embodiment, the present invention provides a system for configuring wireless communication devices that is accessible and easy to operate. Such that, a salesperson is able to operate the system at a store selling wireless phones. In addition, certain embodiments of the present invention are compatible with a wide range of wireless devices. For example, a system according to present invention is capable of connecting and communicating with different types of wireless communication devices. Another advantage of a system, in comparison to the present invention, is the ability to perform a variety of functions on a cellular phone in many ways. For example, the system is capable of unlocking and/or flashing a mobile station, as well as the ability to upload a myriad of media, such as ringtones and movies, and software to the mobile station. The benefits are non-inclusive to the above-mentioned.

Depending upon embodiment, one or more of these benefits may be achieved. These benefits and various additional objects, features, and advantages of the present invention can be fully appreciated with reference to the detailed description and accompanying drawings that follow.

### BRIEF DESCRIPTION OF THE DRAWINGS

FIG. 1 is a simplified diagram illustrating a system for configuring wireless devices according to an embodiment of the present invention.

FIG. 2 is a simplified diagram illustrating internal structure of a system for configuring wireless devices according to an embodiment of the present invention.

FIG. 3 is a simplified diagram illustrating a controller component according to an embodiment of the present invention.

FIG. 4 is a simplified flow diagram illustrating operation of a system for configuring wireless devices according to an embodiment of the present invention.

FIG. 5 is a simplified diagram illustrating a service system according to an embodiment of the present invention.

FIG. 6 is a simplified illustrating a process according to an embodiment of the present invention.

### DETAILED DESCRIPTION OF THE INVENTION

The present invention relates in general to telecommunication techniques. More particularly, the invention provides a method and system for wireless communication devices. In a specific embodiment, the present invention provides a standalone system for interfacing and customizing (e.g., flashing CDMA mobile devices, unlocking GSM mobile devices, etc.) wireless communication devices. The invention is described as it applies to wireless communication systems and techniques thereof; but it should be recognized that the invention has a broader range of applicability.

As described above, improved systems and methods for communicating and configuring wireless communication devices (e.g., mobile phones, pagers, etc.).

Configuring wireless communication devices has a wide range of applications (e.g., flashing the mobile stations, upload ring tones, upgrade software, etc.). Certain applications that involve “flashing” or “unlocking” a mobile phone entails a “locked” phone, more specifically, one having been configured to be used only within a specific geographical region or a specific wireless provider. Therefore, an owner of a mobile station that is locked for a specific wireless cannot be used with a different wireless network. Unfortunately, if the owner decided to use the locked mobile station at a different wireless network, the locked mobile station must be “flashed” and/or “unlocked” prior to any type of re-configuration. Flashing and/or unlocking a cellular phone involve configuring internal software, typically through firmware of a mobile device, via a wired connection.

In the past, configuring wireless communication devices has usually been inconvenient, expensive, and difficult. Often, only specialized technicians with complex equipments are capable of configuring mobile wireless communication devices. For example, flashing a CDMA mobile phone involves dedicated equipment. The equipment is dedicated to a particular make and/or model of mobile phones, which includes specific connectors and software. As a result, flashing is often performed by technicians who are specialized in configuring mobile devices. An owner whose mobile phone needs to be configured, whether it be by flashing or unlocking, has to send the mobile phone to the manufacturer of the mobile phone or a specialized service entity and pay a service fee. Local retail entities of mobile phones typically are unable to perform this kind of service. More often than not, the owner is forced to pay a sizable fee for the service and to be deprived of their mobile phone during service installation. Therefore, it is to be appreciated that certain embodiments of the present invention provide, among other things, relatively inexpensive and convenient solution for both owner of mobile communication devices and local retail entities.

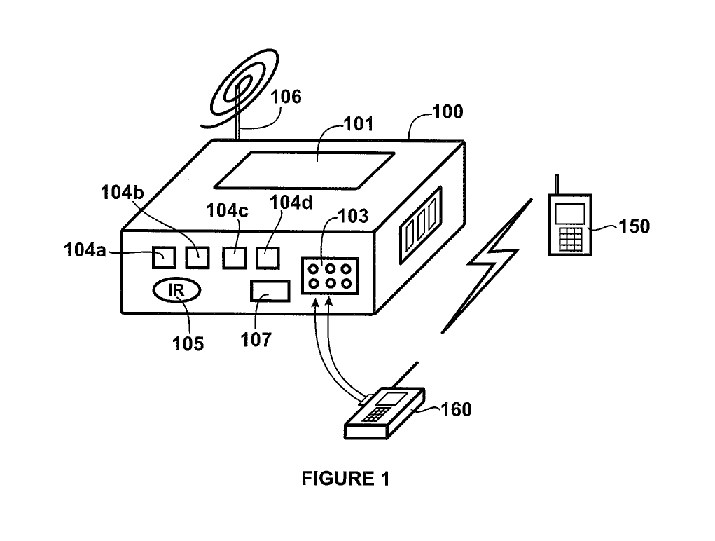

FIG. 1 is a simplified diagram illustrating a system for configuring wireless devices according to an embodiment of the present invention. This diagram is for visual illustration and by no means a representation or unduly limitation of the scope of the claims. One of ordinary skill in the art would recognize many variations, alternatives, and modifications. A system 100, as shown in FIG. 1, includes a display 101, connectors 102, 103, and 107, user inputs 104a-d, infrared port 105, and antenna 106. Specifically, the system 100 has a small size and weight for easy transfer and set up. Thus, the system 100 is easily moved to and set up at a retail entity of mobile communication devices. The system 100 also includes internal components such as processors, program instructions, etc.

Depending upon specific applications, the system 100 connects to wireless mobile devices via a variety of communication ports and/or protocols. For example, the system 100 is connected to a wireless mobile station 150 via a wireless connection such as Bluetooth, infrared, local area network, and CDMA network. According to the embodiment, the system 100 includes an infrared port for interfacing with a variety of mobile devices commonly identified as mobile phones, laptops, and personal digital assistants. Also, the system 100 is connected to the wireless mobile station 160 via a wired connection using connector 103. According to certain embodiments, the connector 103 is physically capable of connecting to a variety of mobile devices, not constrained by their make or model. For example, a variety of mobile devices made by different manufacturers use connectors that are physically compatible but different in pin assignments. In a specific embodiment, the connector 103 is used for both data exchange and power transfer. The power transfer supplies power to wireless mobile devices. The system 100 additionally includes a connector 107 for connecting to other devices, such as computers. According to an embodiment, the connector 107 is implemented with a USB compatible connector. According to another embodiment, the connector 107 is implemented with the RJ-45 connector. Depending upon application, other types of connectors (e.g., LPT, serial, etc.) may be used to connect the system to external devices.

According to various embodiments, the system 100 provides a variety of user inputs and outputs. As shown, the system 100 includes a display 101 as user output. The system 100 may include other types of user output, such as blinking indicator, sound, etc. For instance, the display is implemented with liquid crystal display (LCD). Another illustration is where the display is implemented with simple light emitting diode (LED) devices. In addition to the display 101 as shown, the system 101 can be configured to provide signal for external display, similar to an external monitor, etc. The display 101 may be used in many ways to display the status of the system either through connection and/or power. According to a specific embodiment, the display 101 is used to display advertisements. For example, the display 101 displays advertisements from various wireless service providers when the system 100 boots up.

The system 100 offers the capability of options for user inputs. For example, the buttons 104a-d allows user to selects different operating modes for the system 101. As another example, the buttons are used to receive user inputs related to information displayed on the display 101. According to certain embodiments, the system 100 is connected to external input devices (e.g., keyboard, keypad, mouse, etc.). The system 100 is able to operate according received user inputs.

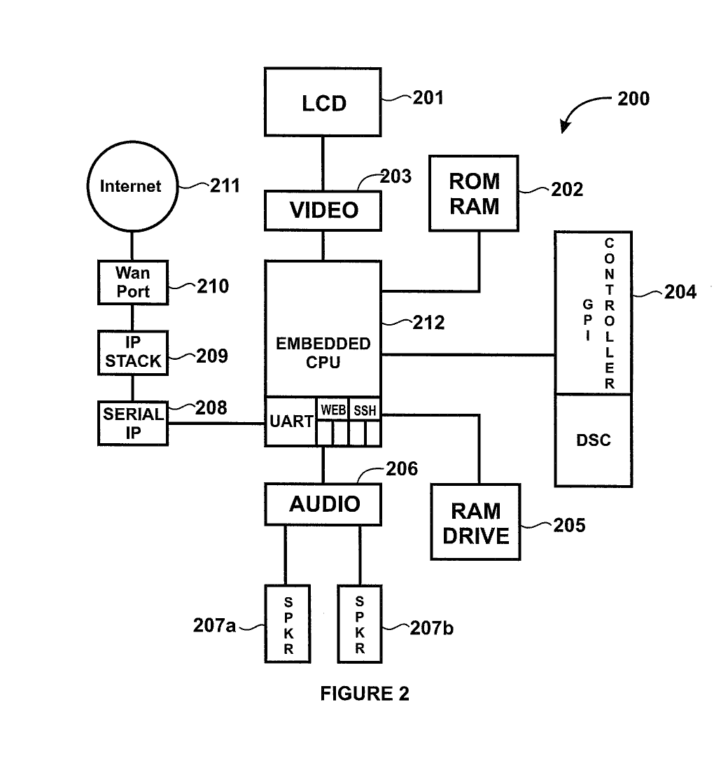

FIG. 2 is a simplified diagram illustrating internal structure of a system for configuring wireless devices according to an embodiment of the present invention. This diagram is merely a visual illustration, not to be mistaken as the representation and unduly limiting the scope of the claims. One of ordinary skill in the art would recognize many variations, alternatives, and modifications. As an example, a system 200 as shown, is the same as the system 100 shown in FIG. 1, reflecting the internal components and structure similar of the system 100.

The system 200 includes, among other things, the following components:

a. an LCD display 201;

b. a memory component 202;

c. a display controller 203;

d. a controller 204;

e. a memory drive 205;

f. an audio controller 206;

g. speakers 207a and 207b;

h. a serial port 208;

i. an IP port 209;

j. a WAN port 210; and

k. a processor 212.

In addition, the system 200 is connected to the Internet 211, in order to obtain various software packages that can be use for configuring wireless mobile devices. According to certain embodiments, the system 200 connects to a dedicated network, which provides various types of software packages and contents such as ringtones and wallpapers.

The LCD display 201 is configured to display information for users. For example, the LCD display 201 is the display 101 in FIG. 1. It is to be understood that the LCD display 201 may be substituted by other types of displays. According to the embodiment, the LCD display 201 is controlled by the display controller 203. Thus, the display controller 203 is capable of processing graphical data and providing display signals to the LCD display 201. According to an embodiment, the display controller 203 results in the capability of providing display signals to external devices.

The memory component 202 is configured to store data. According to an embodiment, the memory component 202 stores both program instructions and digital contents. Depending upon specific implementations, the memory component 202 may include different types of storage medium, such as RAM, ROM, flash memory, hard disk, etc. It is to be appreciated that various embodiments of the present invention provides convenient and integral solution for interfacing and configuring wireless mobile devices. For example, the memory component stores various sets of software packages that are specifically tailored for flashing and/or unlocking wireless mobile devices. Consequently, the storage capability provides software packages that are easier to operate and more specific as compared to software packages offered by the conventional techniques.

The controller 204 is used to connect the system 200 to wireless mobile devices. More specifically, the controller 204 is connected to the connector 103 in FIG. 1 and is capable of providing switching and other types of control for interfacing with a variety of mobile devices. According to an embodiment, the controller 204 includes control logic for determining various properties (e.g., type, make, model, etc.) of a mobile device that is connected to the system 200. Hence, the controller 204 is able to determine the model of a connected mobile device. Based on the determined model of the connected mobile device, the controller 204 can direct an internal switching or wiring configuration for the system 200 so that the system 200 is able to interface with the connected mobile device using the switching configuration. According to an embodiment, the controller 204 includes a switch box that sets up proper wire connections base on the wiring configuration.

In addition to multitude of wired connections, the controller component 204 may also provide other types of interfacing methods, depending upon specific applications. For example, the controller component 204 is used to provide communication interface between the system 200 and a wireless mobile station using wireless data links such as infrared, Bluetooth, etc.

When the system 200 is properly connected to a wireless mobile device, the processor 212 is able to perform a variety of functions. In that given situation, the processor 212 reads and processes program instructions that are stored at the memory component 202. As shown, the processor 212 is comprised of various components, including the IP port 208, the display controller 203, the audio controller 206, the memory component 202, the memory controller 205, and the controller component 204, which are integral ingredients of the system. Depending upon application usage, the processor 202 may perform various interfaces. For example, the processor 202 includes an embedded and various communication interface and connections. More specifically, the processor 202 includes universal asynchronous receiver transmitter (UART) for communicating mobile devices that are connected to the system 200 through the controller component 204. As a result, the controller component 204 provides proper switching and/or wiring between the UART port of the processor 202 and the connected wireless mobile device.

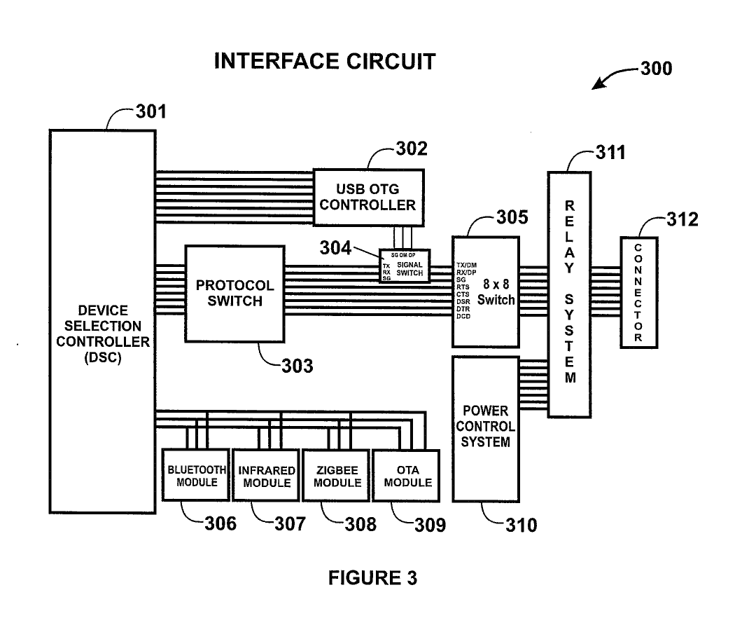

According to certain embodiments, the system 200 is connected to wireless mobile devices through the controller component 204. FIG. 3 is a simplified diagram illustrating a controller component according to an embodiment of the present invention. This diagram is merely an example, which should not unduly limit the scope of the claims. One of ordinary skill in the art would recognize many variations, alternatives, and modifications. As shown in FIG. 3, a controller component 300 includes the following components:

1. a device selection controller (DSC) 301;

2. a USB controller 302;

3. a protocol switch 303;

4. a signal switch 304;

5. a wire switch 305;

6. a Bluetooth module 306;

7. an infrared module 307;

8. a Zigbee module 308;

9. an OTA module 309;

10. a power control system 310;

11. a relay system 311; and

12. a connector 312.

As an example, the controller component 300 is the same as the controller component 204 in FIG. 2. It is to be understood that the controller component 300 has a broad range of applications and may be used in other systems as well.

The controller component 300 provides various interfaces, both wired and wireless interface. As shown in FIG. 3, the connector 312 provides physical connection to wireless mobile devices. For example, the connector 312 is the same as the connector 103 in FIG. 1. According to various embodiments the connector 312 is physically adaptable of connecting to different types of wireless mobile devices that share substantially the same physical characteristics. It is also to be understood that the controller component 300 may include additional physical connectors to fit additional types of wireless mobile devices.

As shown in FIG. 3, the connector 312 is connected to a relay system 311. Depending on the application, the relay system 311 provides various functionalities. The relay system 311 is connected to the wire switch 305 and the power control system 310. For example, data and signal pass through the wire switch 305, and the power passes through the power control system 310. According to certain embodiments, the power control system 310 is configured to provide direct current (DC) power to the connected mobile devices that in turn determines the operating voltage of the connected mobile devices and supplies the devices with the appropriate operating voltage.

The wire switch 305 provides proper wire connections between the DSC 301 and the connected mobile device. According to an embodiment, the DSC 301 determines the type of mobile device that is connected and provides a switching configuration. According to another embodiment, the DSC 301 receives a selection from a user input. Based on the user input, the DSC 310 provides a switching configuration. As an example, the wire switch 305 sets proper wire switching according to the switching configuration.

The wire switch 305 is connected to the signal switch 204 and the protocol switch 303. According to certain embodiments, the protocol switch 303 provides protocol and/or interface related switching. This switch also provides clock and data synchronization with the connected mobile devices. The protocol switch 303 ensures that proper protocol is used for communication between the system and the connected mobile devices.

In a specific embodiment, the signal switch 204 is configured to provide signal switching. In this case, the signal switch 204 ensures that signal paths are established correctly. According to an embodiment and as shown in FIG. 3, the signal switch 204 sends and receives signals from the USB controller 302 and the protocol switch 303, respectively. Ultimately, signal and/or data paths are established between the system and the connected mobile devices.

In addition to the existing wired connections, the controller component 300 may also establish wireless connections with wireless devices. As shown, the controller component 300 includes the Bluetooth module 306, the infrared module 307, the Zigbee module 308, and the OTA module 309 for wireless connections. For example, the Bluetooth module 306 wirelessly connects to wireless mobile devices that have Bluetooth connectivity, i.e, compliant to IEEE 802.15.1 standard. On the one hand, the infrared module 307 connects to wireless mobile devices using infrared link. On the other hand, the Zigbee module 308 similarly connects to wireless mobile devices using wireless low power digital radio connection, i.e., complaint to IEEE 802.15.4 standard. In addition to Bluetooth, infrared, and Zigbee modules, the controller component 300 may also interface with wireless mobile devices via over-the-air (OTA) wireless network using the OTA module 309.

It is to be appreciated that the present invention has a broad range of applications and may be implemented with different configurations. These various modules like the Bluetooth module may be added or removed.

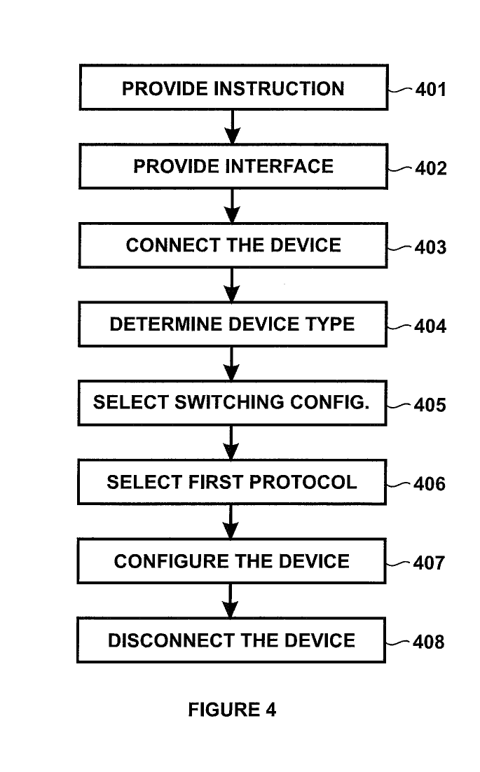

FIG. 4 is a simplified flow diagram illustrating operation of a system for configuring wireless devices according to an embodiment of the present invention. This diagram is merely an example, which should not unduly limit the scope of the claims. One of ordinary skill in the art would recognize many variations, alternatives, and modifications. To illustrate the diversity, various steps may be added, removed, repeated, replaced, combined, overlapped, and/or partially overlapped.

At step 401, a set of instructions is provided. According to an embodiment, the set of instructions is stored by a memory and includes a plurality of protocols for communicating with wireless devices such as the mobile station, personal digital assistant, pagers, etc. More specifically, the set of instruction also includes instructions for the system to operate.

At step 402, an interface is provided. The interface is implemented by the connector 312 in FIG. 3. According to an embodiment, the interface includes at least one connector that is used to physically (e.g., via cable connection) connect to a wireless device. Depending upon application, the interface may include two or more connectors for physically connecting to different types of wireless devices. The connector is adaptable to different types of connector configurations. For example, the connector is capable of conforming to a first configuration and a second configuration. The connector includes a set of pins; of which, the first subset of pins are used to connect to one type of wireless devices with the second subset of pins used to connect to another type of wireless devices. In a specific embodiment, the first configuration is capable of disengageably coupling to a first communication device; the second configuration is capable of disengageably coupling to a second communication device. However, the first communication device and the second communication device are manufactured by different makers. Thus, the first communication device and the second communications devices are configured to connect to different connectors.

At step 403, a communication device is connected to the connector. The wireless communication device can be characterized by a first device, typically in the forms of connector dimensions, connector configuration, communication protocols, etc.

At step 404, the first device type is determined. Depending upon application, the determination can be performed manually and/or automatically. If the determination is performed manually, determination is completed by a dealer visually. The other situation, if the determination is an automatic process performed by the DSC 301, is illustrated in FIG. 3.

At step 405, an initial switching configuration for the first wireless communication device is selected. For example, the switching configuration is selected by the DSC 301 for the wire switch 305 in FIG. 3. Thus, the wire switch 305 is set according to the first switching configuration based on the first device type.

At step 406, a first protocol is selected. For example, the protocol switch 303 in FIG. 3 selects the first protocol based on information associated with the first device type. The protocol switch 303 is capable of selecting many protocols, each of which is for communicating with a specific type of wireless device. The first protocol includes a handshaking protocol for establishing a communication link between the system and the connected wireless device.

At step 407, the system configures the communication device using the first switching configuration and the first protocol. Depending upon application, the configuring process performed by the system includes updating software of the communication device. Essentially, the system “unlocks” a GSM phone by modifying the software of the phone.

At step 408, the communication device is disconnected from the connector. In an embodiment, the process of disconnecting the communication devices involves performing a disconnect process which may include, but not limited to stopping the software from running or shutting down the power circuit at the connector, by the system.

According to an embodiment, the present invention provides a system for customizing. The system includes a user interface for displaying information. The system also includes a user input for receiving one or more type of input. Additionally, the system includes a memory that has a first portion and a second portion. For example, the first portion includes at least one set of program instructions, and the second portion includes at least one set of contents. The system further includes a first interface that includes a connector. For example, the connector is adaptable to a plurality of connector configurations, which may include both a first configuration and a second configuration. As described, the first configuration is capable of disengageably coupling to a first communication device, whereas, the second configuration is capable of disengageably coupling to a second communication device. First communication device and the second communication device are characterized by different makes. The system also includes a switching logic component that is configured to determine a switch configuration. For example, the switch configuration is associated with a communication device that is disengageably coupled to the connector according to the first configuration. Collaborately, the system includes a switching component that is configured to conform to the switch configuration. The system further includes a processor that is configured to execute a first set of program instructions. Therefore, the first set of program instructions is associated with the communication device that is disengageably coupled to the connector. The first set of program instructions then is configured to modify a configuration of the communication device. FIGS. 1-3 illustrates this embodiment.

It is to be appreciated that the device as illustrated in FIG. 2 may have numerous applications in addition to performing system update to cellular phones. According to an embodiment, the device can also be used for receiving payments, which may be related to performing system update date, but may also be related to other product and/or services. For example, to reconfigure a mobile phone, it is often necessary to acquire and/or purchase a special code from a remote server. For example, the entity that performs the reconfiguration procedure has an account at the server's side and customers pay that that entity in cash or credit card payment in return for the service.

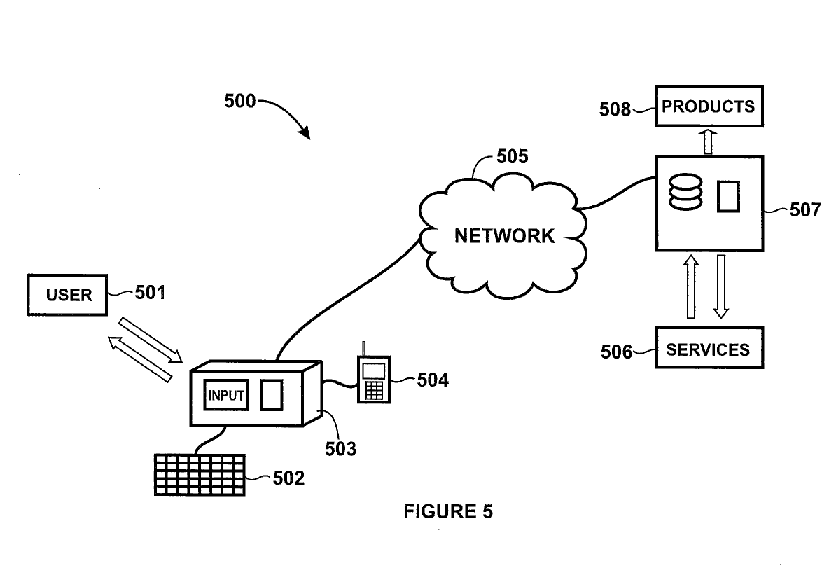

FIG. 5 is a simplified diagram illustrating a service system according to an embodiment of the present invention. This diagram is merely an example, which should not unduly limit the scope of the claims. One of ordinary skill in the art would recognize many variations, alternatives, and modifications.

As shown in FIG. 5, a system 500 includes a server 507 and a receiving device 503. The server 507 is configured to store a plurality of accounts. For example, server 507 contains a database which includes records associated with receiving devices. For example, each of record includes an amount of credits (e.g., prepaid and/or authorized) for the entity owning the receiving device to provide various types of services, such as reconfiguring mobile phones, selling international calling minutes, etc. Depending on the application, the server 507 may be connected to various entities to facilitate the services that are to be provided by the receiving device.

The a receiving device 503 is connected to the server 507 through the network 505. Depending on the application, the network 505 may be various types of network, such as telephone network, IP network, secured/dedicate network, and/or hybrid network. For example, the network is simply a telephone network, in which the receiving device 503 connects to the server 507 via a direct dial up connection. As another example, the network 505 may be the Internet, in which the receiving device 503 and the server 507 establishes a secured connection to communication with each other.

The receiving devices 503 includes, among other things, a user interface and a communication interface. For example, the user interface includes a display and one or more input devices (e.g., keyboard, mouse, etc.). In addition, the receiving device 503 includes a communication interface, which may be a data port or even a wireless communication interface, for connecting to the network 505. According to a specific embodiment, the device 503 is connected to the system 100 to help obtain system configuration codes from the server 507. For example, the receiving device 503 receives a payment from a user 501 for unlocking a mobile device, requests an unlocking code from the server, receives the code from the server 507, and provides the unlocking code to the system 100, which uses the unlocking code to unlock the mobile device. In an embodiment, the receiving device 503 is an integral part of the system 100.

The receiving device 503 is connected to the server 507 to obtain products and/or services from the server 507 in return for the payment received at the receiving device 503 end. For example, the server 507 is connected to many receiving devices. The server 507 stores accounts for these receiving devices. In a specific embodiment, each account is associated with an amount of credits (e.g., airtime for cell phone, minute usage for long distance phone calls, credit for paying bills, etc.).

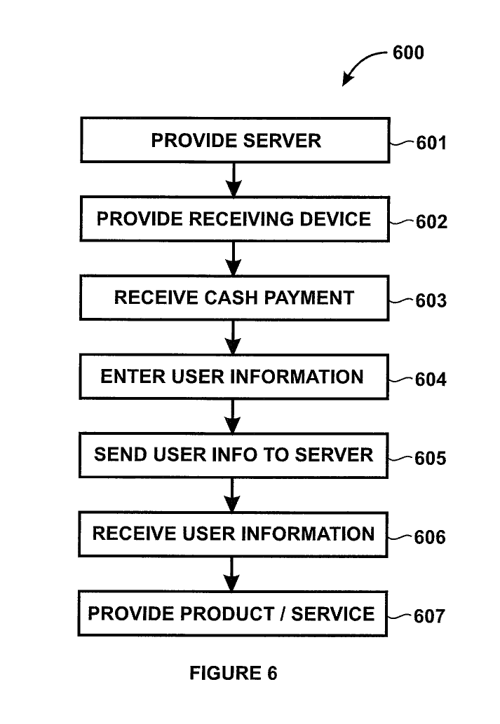

FIG. 6 is a simplified illustrating a process according to an embodiment of the present invention. This diagram is merely an example, which should not unduly limit the scope of the claims. One of ordinary skill in the art would recognize many variations, alternatives, and modifications.

At step 601, a server is provided. The server includes, among other things, a database for storing account information. For example, account information includes available credit information for account holders, who may have prepaid account set up at the server. As an example, the server is explain above and illustrated in FIG. 5.

At step 602, a receiving device is provided. According to embodiments, the receiving device is connected to the server. For example, the receiving device is connected to the server via a network. The receiving device includes, among other things, a user interface and a communication interface. For example, the receiving device is discussed above and illustrated in FIG. 5.

At step 603, cash payment is received from a customer at the receiving device. For example, an operator of the receiving receives cash payment from a customers. As another example, the receiving device is configured to receive and hold bills using a bill or coin validator.

At step 604, user information is entered at the receiving device in response to the payment received. Depending on the application, the user information include account information for the person who paid the bill, a request for unlocking code for unlocking mobile phones, an amount of airtime to be purchased for a mobile phone, a minute usage for a calling card for placing long distance and/or international phone calls, etc. In a specific embodiment, user information is entered by a text message from a mobile device.

At step 605, the entered user information is sent to the server through the communication network. For example, the receiving device stores the information entered at step 604 and sends the information to the server. In a specific embodiment, the user information is sent using a secured connection and/or encrypted.

At step 606, the server stores the received user information. For example, the user information is stored in a data and linked to the account associated with the receiving device. In addition to storing the information, the server may perform other functions as well. The server may also deduct an amount of credits based on the received user information. For example, the user information is associated with requests an unlocking code for a mobile phone, and the server deducts the number of unlocking code credit from the account associated with the receiving device. As another example, the user information is associated with recharging a long distance phone card, and the server deducts the number of long distance minute credits from the receiving device's account.

At step 607, the server provides products and/or services in response to the request. For example, the server sends unlocking codes to the receiving device, which uses it to reconfigure a mobile device. As another example, the server add minutes to a long distance phone card. In another example, the server sends a payment to a utility company on behalf of the user. There are other variations as well.

It is to be appreciated that the device and method illustrated in FIGS. 5 and 6 have a wide range of applications, such as selling international calling card minutes, sending money to individuals and/or large entities, and many more.

According to an embodiment, a new payment box that is very easy to use and is very simple with no monthly fees for the merchant. The features of this box includes:

a) To sell international calling card minutes;

b) To be able to send money up to $200 per transaction such that user or receiver can go to any participating retailer (predefined in our system by transaction limits);

i) our system would utilize a unique way to send money to create a more secure method to send cash;

ii) the sender and receiver would be required to coordinate in making a cash transfer transaction;

iii) both parties will be required to separately create a 10 digit authorization number to be labeled as sender and receiver codes (these will be user defined); and

iv) when the sender arrives at the location to send money they will be required to input in order:
a) destination zip code;
b) sender authorization code; and
c) receiver authorization code.

v) if the combination of the above 3 is already in our system as a pending transaction, the sender will be required to enter a new number which the system will also be able to identify as a different authorization code in the event the receiver does not communicate with the sender in time;

vi) when the receiver arrives at the destination location they will be required to input both codes in the following order:
a) receiver authorization code; and
b) sender authorization code; and

vii) this will ensure an additional security measure by splitting the responsibility of the authorization code privacy to both sender and receiver.

viii) the cash distribution method will be unique in that an auction will be presented to those locations in the zip code that are willing to bid for a lower rate. The retailer will predefine their rate at a lower than normal cost percentage and then if they qualify (do not surpass daily limits) they can become the preferred retailer for the transaction.

ix) the retailer would be setup on a direct debit system either with a credit card or a business checking account, or other commercial means, ie paypal, etc. When the Sender sends the funds it will be debited immediately.

c) To accept payments for participating resellers:

i) prepaid phone carriers; and

ii) utility, phone, credit cards, etc.

It is to be appreciated that the embodiment is revolutionary concept that will fill two major voids in the small business and telecommunication markets. There are many advantages for all involved both the seller and the buyer. Due to the exorbitant rates for international calling in this day and age almost all international callers use calling cards. Purchasing calling cards is a very limited business concentrated mostly to major supermarkets, convenience stores, etc. The goal of this box is to make just about any retail outlet with a phone line a payment center for any of the above mentioned services. This allows an additional “item” to sell that has nothing to do with their own business but creates a greater opportunity to market to the same customer base that may need such services.

By allowing so many smaller retail stores to have such a system it will also take advantage of the huge amount of manpower. Since a good salesperson can sell anything the idea is to create an army of salespeople with just commission based strictly on volume.

Upon finishing, the customer can use the system illustrated above to obtain long distance minutes. For example, the receiving device is connected to the server for providing long distance minutes, and the following information is entered:

a) The phone number/account for long distance minutes.

b) If not, is a pin number needed?

c) Is it necessary to add additional minute usage to other accounts and/or telephone numbers.

The other powerful use of the box is as a payment tool. This is not as necessary state side though there is still a considerable demand for such services. In certain developing countries where modern technology and infrastructures are still severely lacking, the less privileged that can't qualify for a credit card or any other secured payment method are required to stand in long lines regularly to pay their bills with cash.

The other major application for this box is a single point cash payment service. As mentioned earlier in small amounts (e.g., under $200) of cash can be sent as an alternative to western union. Western union's current fee of almost 15% of the cost of the money would be challenged significantly!

According to an embodiment, the present invention provides a system for receiving one or more payments. The system includes a server that is configured to store a plurality of accounts. For example, the plurality of accounts including at least a first account. The system also includes a receiving device, the receiving device being connected to the server. The receiving device includes at least a user interface and a communication interface. The receiving device being associated with the first account. The receiving device is configured to enter information associated with a cash payment and the product and/or service from a customer. The receiving device is further configured to send the information to the server over a communication network. The server is configured to store payment information by the server. The server is further configured to facilitate providing the product and/or service.

According to another embodiment, the present invention provides a system for customizing wireless communication devices. The system includes a user interface for displaying information. The system also includes a user input for receiving one or more user input. The system additionally includes a memory that includes a first portion and a second portion. For example, the first portion including at least one set of program instructions. The system also includes a first interface, which includes a connector. For example, the connector is adaptable to a plurality of connector configurations, which includes a first configuration and a second configuration. For example, the first configuration is capable of disengageably coupling to a first communication device, and the second configuration is capable of disengageably coupling to a second communication device. The first communication device and the second communication device are characterized by different makes. The system further includes a selecting component, which is configured to select a switch configuration based on the one or more user input. The switch configuration is associated with a communication device that is disengageably coupled to the connector according to the first configuration. Additionally, the system includes a switching component, the switching component be configured to conform to the switch configuration. Also, the system includes a processor that is configured to execute a first set of program instructions. For example, the first set of program instructions is associated with the communication device that is disengageably coupled to the connector. The first set of program instructions is configured to modify a configuration of the communication device. For example, the embodiment is illustrated according to FIGS. 1-3.

It is to be appreciated various embodiments of the present invention provide numerous advantages over conventional techniques. In a specific embodiment, the present invention provides a system for configuring wireless communication devices that is accessible and easy to operate. For example, a sales person is able to operate the system at a store selling wireless phones. In addition, certain embodiments of the present invention are compatible with a wide range of wireless devices. For example, a system according to present invention is capable of connecting and communicating with different types of wireless communication devices. Another advantage of a system according to the present invention is the ability to perform a variety of functions on a cellular phone in many ways. For example, the system is capable of unlocking and/or flashing a mobile station, and is also able to upload ring tone and software to the mobile station. There are other benefits as well.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A system for customizing wireless communication devices comprising:
a user interface for displaying information;
a user input for receiving one or more user input;
a memory including a first portion and a second portion, the first portion including at least one set of program instructions, the second portion including at least one set of contents;
a first interface, the first interface including a connector, the connector being adaptable to a plurality of connector configurations, the plurality of connector configurations including a first configuration and a second configuration, the first configuration being capable of disengageably coupling to a first communication device, the second configuration being capable of disengageably coupling to a second communication device, first communication device and the second communication device being characterized by different makes;
a switching logic component, the switching logic component being configured to determine a switch configuration, the switch configuration being associated with a communication device that is disengageably coupled to the connector according to the first configuration;
a switching component, the switching component be configured to conform to the switch configuration; and
a processor being configured to execute a first set of program instructions, the first set of program instructions being associated with the communication device that is disengageably coupled to the connector, wherein the first set of program instructions is configured to modify a configuration of the communication device.

2. The system of claim 1 further comprises a second interface, the second interface being configured to wireless communicate with a plurality of communication devices.

3. The system of claim 1 wherein the user interface comprises a liquid crystal display.

4. The system of claim 1 wherein the memory comprises a hard disk.

5. The system of claim 1 wherein the memory comprises a non-volatile memory.

6. The system of claim 1 wherein the first configuration is characterized a first physical arrangement and the second configuration is characterized a second physical arrangement, the first arrangement and the second arrangement being different.

7. The system of claim 1 wherein the first configuration is characterized a first physical arrangement and the second configuration is characterized a second physical arrangement, the first arrangement and the second arrangement being the same.

8. The system of claim 1 wherein the communication device is a locked GSM phone and the first set of program instructions is configured to unlock the locked GSM phone.

9. The system of claim 1 wherein the communication device is a locked CDMA phone and the first set of program instructions is configured to unlock the locked CDMA phone.

10. The system of claim 1 further comprises a power supply, the power supply being configured to provide power at a predetermined power level, the predetermined power level being associated with the communication device that is disengageably coupled to the connector.

11. The system of claim 1 further comprises a second interface, the second interface being capable of interfacing with at least a computer.

12. The system of claim 1 further comprises a second communication interface, the second communication interface being connected to the Internet.

13. The system of claim 1, wherein the user input comprises a keypad.

14. The system of claim 1, wherein the user input comprises a plurality of buttons.

15. A system for customizing wireless communication devices comprising:
a user interface for displaying information;
a user input for receiving one or more user input;
a memory including a first portion and a second portion, the first portion including at least one set of program instructions;
a first interface, the first interface including a connector, the connector being adaptable to a plurality of connector configurations, the plurality of connector configurations including a first configuration and a second configuration, the first configuration being capable of disengageably coupling to a first communication device, the second configuration being capable of disengageably coupling to a second communication device, first communication device and the second communication device being characterized by different makes;
a selecting component, the selecting component being configured to select a switch configuration based on the one or more user input, the switch configuration being associated with a communication device that is disengageably coupled to the connector according to the first configuration;
a switching component, the switching component be configured to conform to the switch configuration; and
a processor being configured to execute a first set of program instructions, the first set of program instructions being associated with the communication device that is disengageably coupled to the connector, wherein the first set of program instructions is configured to modify a configuration of the communication device.

16. The system of claim 15 further comprising a network interface, wherein the network interface is connected to a server to send payment information associated, the payment information being associated with the modifying the configuration of the communication device.

17. The system of claim 15 further comprises a second interface, the second interface being configured to wireless communicate with a plurality of communication devices.

18. The system of claim 15 wherein the user input comprises selecting a make of communication devices, the make of communication devices being associated with the communication device.

19. The system of claim 15 wherein the at least one set of contents comprises multimedia contents.

20. The system of claim 15 wherein the at least one set of contents comprises one or more ring tones.

21. A method for configuring one or more wireless communication devices, the method comprising:
providing a set of instructions, the set of instructions including a plurality of protocols;
providing at least one interface, the at least one interface including a connector, the connector being adaptable to a plurality of connector configurations, the plurality of connector configurations including a first configuration and a second configuration, the first configuration being capable of disengageably coupling to a first communication device, the second configuration being capable of disengageably coupling to a second communication device, first communication device and the second communication device being characterized by different makes;
connecting a communication device to the connector, the communication device being characterized by a first device type;
determining the first device type;
selecting a first switching configuration for the communication device, the first switching configuration being associated with the first device type;
selecting a first protocol, the first protocol being one of the plurality of protocols, the first protocol being associated with the first device type;
configuring the communication device using the first switching configuration and the first protocol; and
disconnecting the communication device from the at least one connector.

22. The method of claim 21 further comprising receiving a payment for configuring the communication device.

23. The method of claim 21 furthering comprising providing power for the third communication device.

24. The method of claim 21 wherein the configuring the third communication device comprises flashing the communication device.

25. The method of claim 21 wherein the configuring the third communication device comprises flashing the communication device, the third communication device being a CDMA phone.

26. The method of claim 21 wherein the configuring the third communication device comprises unlocking the communication device.

27. The method of claim 21 wherein the configuring the third communication device comprises unlocking the communication device, the third communication device being a GSM phone.

28. The method of claim 21 wherein the third communication device is configured to be operable only within a first network, the configuring the third communication device enabling the third communication device to be operable within a second network, the first network and the second network being different.

29. A method for receiving one or more payments, the method comprising:
providing a server, the server including a database for storing account information;
providing a receiving device, the receiving device being connected to the server, the receiving device including at least a user interface;
receiving a cash payment from a customer, the payment being associated to a product and/or service;
entering information associated with the cash payment and the product and/or service;
sending the information to the server over a communication network;
storing payment information by the server; and
providing the product and/or service.

30. The method of claim 29 further comprising creating an authorization code associated with the product and/or service.

31. The method of claim 29 furthering comprising:
providing an identification associated with the customer;
selecting a service provider based on the identification.

32. The method of claim 29 further comprising setting up an account at the server, the account being associated with the receiving device.

33. The method of claim 29 furthering comprising setting up an prepaid account at the server, the prepaid account being associated with the receiving device.

34. The method of claim 29 wherein the service comprises paying for a utility bill.

35. The method of claim 29 wherein the service comprises paying for a phone bill.

36. The method of claim 29 wherein the product comprises a prepaid phone carrier.

37. The method of claim 29 wherein the information includes at least a cell phone number of the customer.

38. A system for receiving one or more payments, the system comprising:
a server, the serving being configured to store a plurality of accounts, the plurality of accounts including at least a first account; and
a receiving device, the receiving device being connected to the server, the receiving device including at least a user interface and a communication interface, the receiving device being associated with the first account;
wherein:
the receiving device is configured to enter information associated with a cash payment and the product and/or service from a customer;
the receiving device is further configured to send the information to the server over a communication network;
the server is configured to store payment information by the server;
the server is further configured to facilitate providing the product and/or service.

39. The system of claim 38 wherein the receiving device further comprises a device interface for connecting to a cellular phone.

40. The system of claim 38 wherein the receiving device is further configured to perform flashing for a cellular phone.

41. A method for dynamically configuring operating characteristics of a receiving device, the method comprising:
providing the receiving device, the receiving device being connected to the server over a communication network;
providing a server, the server including a plurality of configuration files for receiving devices operation modes, the device operation modes including customizable operation of payments, notification, flashing, data transfer, data backup, data retrieval and unlocking;
modifying the plurality of configuration files determined by a receiving device identity stored in a server database;
providing a user input;
configuring user input by modifying the plurality of configuration files; and
displaying information associated with the receiving device operation modes.

42. A method for storing data from wireless communication devices and transferring data from on wireless communications device to another wireless communication device for information delivery.

43. The method of claim 41 wherein the data comprise media transfers from one wireless communication device to another wireless communication device or devices.

44. A method of claim 41 wherein the information delivery includes to the receiver device, push or, pulled form the server by the receiver device.

45. The method of claim 41 wherein the information consists of industry specific information to the wireless communication devices information files accessed by the server.

46. The method of claim 41 wherein the information is received by a user input request from a receiver device to the server over the communication network to display or play on the receiver device.

47. The method of claim 41 wherein the information is pushed by the server automatically to the receiver device over the communication network to display or play information on the receiver device.

48. The method of claim 41 wherein the information is request by a user input into the receiver device to request specific information for a wireless communication device over the communication network to the server i.e. operating instruction for the wireless communication device or programming instruction for the wireless communication device, vendor list.

49. The method of claim 41 allows a user configurable data list. The user is able to inquire our server database for updated information. Therefore, not limiting the user to data captured in the box; thus, providing the user freedom to update device information live. By keying in the alphabetical text of a new possible payee, the system would update the data upon request and make available the new payee, as long as payee is within a constantly updated database. Reference to the new payee will be updated on the user's device such that it will be stored in the main memory of the unit.

50. The method of claim 41 wherein the data comprise contact information from a wireless communication device to another wireless communication device or devices.

51. A system for storing data from wireless communication devices and transferring data from on wireless communications device to another wireless communication device.

52. The system of claim 51 further comprising wherein the wireless communication device has a capability to backup a plurality of wireless devices in a same time frame using a plurality of interface methods, the interface methods include wired and wireless communication.

53. The system of claim 51 further comprising a capability to convert formats from one wireless device format to another wireless device format for data transfer.

54. The system of claim 51 further comprising a mean for live-transferring from a plurality of wireless devices.

55. The system of claim 51 further comprising a mean for storing and forwarding data from one wireless communications device to another wireless communication device.

56. The system of claim 51 further comprising a mean for backing up wireless devices to a service data storage system.

57. The system of claim 51 further comprising a mean for retrieving stored data from one of receiver locations connected to the server communication network.
